(19) United States
(12) Patent Application Publication
(10) Pub. No.: US 2025/0006205 A1
(43) Pub. Date: Jan. 2, 2025

(54) DETECTING DEEPFAKE AUDIO USING TURBULENCE

(71) Applicant: UNIVERSITY OF FLORIDA RESEARCH FOUNDATION, INCORPORATED, Gainesville, FL (US)

(72) Inventors: Patrick G. TRAYNOR, Gainesville, FL (US); Kevin BUTLER, Gainesville, FL (US); Daniel OLSZEWSKI, Gainesville, FL (US); Logan E. BLUE, Gainesville, FL (US); Magdelena PASTERNAK, Gainesville, FL (US)

(21) Appl. No.: 18/748,590

(22) Filed: Jun. 20, 2024

Related U.S. Application Data
(60) Provisional application No. 63/510,721, filed on Jun. 28, 2023.

(51) Int. Cl. G10L 17/26; G10L 17/02

(52) U.S. Cl. CPC G10L 17/26; G10L 17/02

(57) ABSTRACT

A method is provided for identifying synthetic “deepfake” audio samples versus organic audio samples. Methods may include: receiving an audio sample comprising speech; converting the speech to text; aligning the text with phonemes identified within the audio sample; filtering the audio sample to only contain predetermined phonemes; obtaining, from the audio sample, a frequency response vector for each of the predetermined phonemes; transforming the frequency response vector for each of the predetermined phonemes to a classification space vector for each of the predetermined phonemes having a magnitude; normalizing the classification space vector for each of the predetermined phonemes; identifying each of the predetermined phonemes as one of synthetic or organic based on the classification space vector for each of the predetermined phonemes; and identifying the audio sample as synthetic or organic based on identification of each of the predetermined phonemes as one of synthetic or organic.

### CROSS-REFERENCE TO RELATED APPLICATIONS

This application claims priority to U.S. Provisional Application Ser. No. 63/510,721, filed on Jun. 28, 2023, the contents of which are hereby incorporated by reference in their entirety.

### ACKNOWLEDGEMENT OF FUNDING

This invention was made with government support under N00014-21-1-2658 awarded by US Navy Office of Naval Research. The government has certain rights in this invention.

### TECHNOLOGICAL FIELD

An example embodiment of the present disclosure relates to distinguishing between organic audio produced by a person and synthetic “deepfake” audio produced digitally, and more particularly, to detecting deepfake audio using analysis of turbulent flows.

### BACKGROUND

The ability to generate synthetic human voices has long been a dream of scientists and engineers. Over the past 50 years, techniques have included comprehensive dictionaries of spoken words and formant synthesis models which can create new sounds through the combination of frequencies. While such techniques have made important progress, their outputs are generally considered robotic and easily distinguishable from organic speech. Recent advances in generative machine learning models have led to dramatic improvements in synthetic speech quality, with convincing voice reconstruction now available to groups including patients suffering from the loss of speech due to medical conditions and grieving family members of the recently deceased.

While a powerful and important enabler of communication for individuals who agree to use their voices in this fashion, such models also create significant problems for users who have not given their consent. Specifically, generative machine learning models now make it possible to create unauthorized synthetic voice files or “audio deepfakes”, which allow an adversary to simulate a targeted individual speaking arbitrary phrases. While public individuals have long been impersonated, such tools make impersonation scalable, putting the general population at a greater potential risk of having to defend itself against allegedly recorded remarks. In response, researchers have developed detection techniques using bi-spectral analysis (i.e., inconsistencies in the higher order correlations in audio) and training machine learning models as discriminators; however, both are highly dependent on specific, previously observed generation techniques to be effective.

### BRIEF SUMMARY

A method, apparatus, and computer program product are provided in accordance with an example embodiment for distinguishing between organic audio produced by a person and synthetic audio produced digitally, and more particularly, to detecting deepfake audio using analysis of turbulent flows. Embodiments include an apparatus having at least one processor and at least one memory including computer program code, the at least one memory and the computer program code configured to, with the processor, cause the apparatus to: receive an audio sample including speech; convert the speech into text; align the text with phonemes identified within the audio sample; filter the audio sample to only contain predetermined phonemes; obtain, from the audio sample, a frequency response vector for each of the predetermined phonemes; transform the frequency response vector for each of the predetermined phonemes to a classification space vector for each of the predetermined phonemes having a magnitude; normalize the classification space vector for each of the predetermined phonemes; identify each of the predetermined phonemes as one of synthetic or organic based on the classification space vector for each of the predetermined phonemes; and identify the audio sample as synthetic or organic based on identification of each of the predetermined phonemes as one of synthetic or organic.

According to some embodiments, the predetermined phonemes include fricative phonemes, plosive phonemes, and nasal phonemes. According to some embodiments, causing the apparatus to transform the frequency response vector for each of the predetermined phonemes to the classification space vector for each of the predetermined phonemes includes fitting a Weiner filter to the frequency response vector for each of the predetermined phonemes. The Weiner filter of an example embodiment computes a statistical estimation of the frequency response vector for each of the predetermined phonemes as an unknown signal using a related known signal. The Weiner filter of an example embodiment attempts to find an ideal linear transformation mapping the unknown signal to the related known signal.

According to some embodiments, the known signal is a seed, where the apparatus is further caused to: determine the seed for a given phoneme by: grouping together the classification space vectors for the given phoneme to form a grouped classification space vector; and finding a maximum absolute value for each dimension of the grouped classification space vector. According to some embodiments, causing the apparatus to obtain, from the audio sample, the frequency response vector for each of the predetermined phonemes includes causing the apparatus to: apply a Discrete Fourier Transform to the audio sample to convert the audio sample from a time domain signal to a complex frequency domain; and obtain the frequency response vector for each of the predetermined phonemes in the complex frequency domain.

According to some embodiments, causing the apparatus to identify each of the predetermined phonemes as one of synthetic or organic based on the classification space vector for each of the predetermined phonemes includes causing the apparatus to: compare the classification space vector for each of the predetermined phonemes to a threshold; and one of: determine that one of the predetermined phonemes is synthetic in response to the classification space vector for the one of the predetermined phonemes failing to satisfy a threshold; or determine that the one of the predetermined phonemes is organic in response to the classification space vector for the one of the predetermined phonemes satisfying the threshold. Causing the apparatus to identify the audio sample as synthetic or organic based on identification of each of the predetermined phonemes as one of synthetic or organic includes, in some embodiments, causing the apparatus to identify the audio sample as synthetic in response to more than five percent of the predetermined phonemes being identified as synthetic.

Embodiments provided herein include a method including: receiving an audio sample comprising speech; converting the speech to text; aligning the text with phonemes identified within the audio sample; filtering the audio sample to only contain predetermined phonemes; obtaining, from the audio sample, a frequency response vector for each of the predetermined phonemes; transforming the frequency response vector for each of the predetermined phonemes to a classification space vector for each of the predetermined phonemes having a magnitude; normalizing the classification space vector for each of the predetermined phonemes; identifying each of the predetermined phonemes as one of synthetic or organic based on the classification space vector for each of the predetermined phonemes; and identifying the audio sample as synthetic or organic based on identification of each of the predetermined phonemes as one of synthetic or organic.

According to some embodiments, the predetermined phonemes include fricative phonemes, plosive phonemes, and nasal phonemes. Transforming the frequency response vector for each of the predetermined phonemes to the classification space vector for each of the predetermined phonemes includes, in some embodiments, fitting a Weiner filter to the frequency response vector for each of the predetermined phonemes. The Weiner filter of an example embodiment computes a statistical estimation of the frequency response vector for each of the predetermined phonemes as an unknown signal using a related known signal. The Weiner filter of certain embodiments attempts to find an ideal linear transformation mapping the unknown signal to the related known signal.

According to some embodiments, the known signal is a seed, where the method further includes: determining the seed for a given phoneme by: grouping together the classification space vectors for the given phoneme to form a grouped classification space vector; and finding a maximum absolute value for each dimension of the grouped classification space vector. According to some embodiments, obtaining, from the audio sample, the frequency response vector for each of the predetermined phonemes includes: applying a Discrete Fourier Transform to the audio sample to convert the audio sample from a time domain signal to a complex frequency domain; and obtaining the frequency response vector for each of the predetermined phonemes in the complex frequency domain.

According to certain embodiments, identifying each of the predetermined phonemes as one of synthetic or organic based on the classification space vector for each of the predetermined phonemes includes: comparing the classification space vector for each of the predetermined phonemes to a threshold; and one of: determining that one of the predetermined phonemes is synthetic in response to the classification space vector for the one of the predetermined phonemes failing to satisfy a threshold; or determining that the one of the predetermined phonemes is organic in response to the classification space vector for the one of the predetermined phonemes satisfying the threshold. According to some embodiments, identifying the audio sample as synthetic or organic based on identification of each of the predetermined phonemes as one of synthetic or organic comprises: identifying the audio sample as synthetic in response to more than five percent of the predetermined phonemes being identified as synthetic.

Embodiments provided herein include a computer program product including at least one non-transitory computer-readable storage medium having computer-executable program code instructions stored therein, the computer-executable program code instructions including program code instructions to: receive an audio sample comprising speech; convert the speech into text; align the text with phonemes identified within the audio sample; filter the audio sample to only contain predetermined phonemes; obtain, from the audio sample, a frequency response vector for each of the predetermined phonemes; transform the frequency response vector for each of the predetermined phonemes to a classification space vector for each of the predetermined phonemes having a magnitude; normalize the classification space vector for each of the predetermined phonemes; identify each of the predetermined phonemes as one of synthetic or organic based on the classification space vector for each of the predetermined phonemes; and identify the audio sample as synthetic or organic based on identification of each of the predetermined phonemes as one of synthetic or organic. According to some embodiments, the predetermined phonemes include fricative phonemes, plosive phonemes, and nasal phonemes.

### BRIEF DESCRIPTION OF THE DRAWINGS

Having thus described example embodiments of the disclosure in general terms, reference will now be made to the accompanying drawings, which are not necessarily drawn to scale, and wherein:

FIG. 1 illustrates the portions of a person's vocal tract according to an example embodiment of the present disclosure;

FIG. 2 illustrates examples of both a laminar and a turbulent flow according to an example embodiment of the present disclosure;

FIG. 3 depicts a process flow of an overview of embodiments described herein when in the detection phase according to an example embodiment of the present disclosure;

FIG. 4 illustrates the distribution of the classification magnitudes for both organic and synthetic phonemes according to an example embodiment of the present disclosure;

FIG. 5 illustrates the mean (x-axis) and standard deviation (y-axis) of the values for each of the 50 dimensions within the classification vectors according to an example embodiment of the present disclosure;

FIG. 6 illustrates empirical cumulative distribution functions (ECDF) for the three phonemes: /n/,/h/, and/e/according to an example embodiment of the present disclosure;

FIG. 7 illustrates the varying performance of different phonemes according to an example embodiment of the present disclosure;

FIG. 8 illustrates the overall performance of each seed evaluated using ten detectors according to an example embodiment of the present disclosure;

FIG. 9 illustrates results for the precision and recall for these simulations as N is swept from 1 to 100 according to an example embodiment of the present disclosure;

FIG. 10 illustrates results of the deepfake detector using the ASVspoof dataset according to an example embodiment of the present disclosure; and

FIG. 11 is a flowchart of a method for identifying deepfake audio according to an example embodiment of the present disclosure.

### DETAILED DESCRIPTION

Example embodiments of the present disclosure will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present disclosure. Thus, use of any such terms should not be taken to limit the spirit and scope of embodiments of the present disclosure.

Speech generation tools (e.g., generative machine learning models) create audio that convincingly imitates human speakers. While these tools can potentially provide significant benefit to people, they can also be used to imitate anyone without consent to cause adverse effects. Such non-consensual, generated audio is also known as a “deepfake” or “deepfake audio”. The overwhelming majority of detection mechanisms against audio deepfakes that rely on machine learning techniques are susceptible to adaptive adversaries and are almost exclusively tested on a single dataset. Embodiments described herein address this open and challenging problem by measuring the complex airflows in human sounding speech.

Embodiments apply a convolutional Wiener filter to build a baseline comparison of the turbulent flows for each individual phoneme and show that audio deepfakes are unable to properly model this extremely computationally intensive physical phenomenon. Embodiments described herein can detect audio deepfakes with up to 100% precision and 99.2% recall. Through the use of multiple concurrent filters, embodiments prevent an adaptive adversary from evading detection by iteratively modifying a deepfake. As such, embodiments demonstrate the lack of real turbulence in the generation of synthetic audio is a reliable and robust way of identifying deepfakes.

Generated human-sounding audio has a wide range of practical and important uses. For example, individuals losing their ability to speak due to medical issues can preemptively preserve their voices for use in future conversations. Actors can permit the use of their voice for fixing dialogue without having to return to a sound studio, or even for use after their death. While such generated voices have historically been artificial and robotic sounding, dramatic improvements in generative machine learning have made it such that modern synthetic audios is now often difficult to differentiate from authentic human-spoken speech.

Generated human-sounding audio also has the potential to create substantial problems. Speech generated to sound like a targeted individual without their consent may allow the generating party to manipulate a receiving party into performing potentially dangerous tasks. Deepfake audio can lead to impersonation and fraudulent statements that sound like an actual person being impersonated. The potential hazards, particularly in politics and government, can have history-changing impacts. The inability to distinguish between real and synthetic human speech will have substantial consequences in the future. While there are some attempts to distinguish real audio from synthetic audio, such as low-level signal processing and the use of machine learning, the available techniques generally do not generalize across datasets or stand up against adaptive adversaries.

Embodiments provided herein include a method for detecting deepfake audio based on the complex natural phenomenon of turbulence, or the chaotic way in which air flows in speech. Turbulence is an idea candidate for detecting deepfake audio in that it is relatively easy to measure, though it is extremely computationally expensive to model. As such, while humans naturally produce turbulent flows, generative audio techniques fail to include such effects, rending them measurably different than organic sources of audio.

Embodiments provided herein include a turbulence-based deepfake audio detector that is effective on multiple types of datasets and robust to evasion attempts. Fluid dynamics supports that spoken language contains turbulent flows both at macro and micro scales. While generating audio samples that conform to behaviors in the macro scale, doing so for the macro scale is extremely computationally expensive. Embodiments described herein provide a robust deepfake audio detector through a combination of Wiener filtering and statistical analysis. Existing deepfake audio detectors tend to be useful on single datasets, often overtraining mechanisms on specific artifacts in those datasets. Embodiments described herein translates across datasets, using both TIMIT Acoustic-Phonetic Continuous Speech Corpus and ASVspoof2021 (Automatic Speaker Verification spoofing and countermeasures) datasets as candidates, both of which are standard datasets used for evaluation of automatic speech recognition systems. Embodiments are able to achieve 100% precision and 99.166% recall rates with as little as 6.5 seconds of audio. Further, detection rates increase as more audio becomes available. Traditional adaptive adversaries are unable to use the detector of embodiments described herein to subvert itself without knowing the seed values chosen by the defender which include ten seeds, each of which are 2048 floating point values. Because these seed values can be regularly updated, brute-force efforts by an adversary are entirely ineffective.

Phonemes are the fundamental units of speech. Different compositions of the vocal tract produce the unique sounds associated with individual phonemes. The English language contains phonemes from vowels, fricatives, plosives, affricates, nasals, glides, and diphthongs. The vocal tract creates resonance chambers by maneuvering the tongue and jaw to produce the most common phoneme type, the vowel phoneme (e.g., “/a/” in fun) which accounts for approximately 38% of all English language phonemes. The resulting resonance chambers produce formants, frequencies whose complex relationship determines the vowel sounds. Fricatives, plosives, and nasals rely on turbulent flows throughout the vocal tract to generate sound. These phonemes comprise approximately 16%, 17%, and 11% of all English language phonemes, respectively.

Fricatives (e.g., “/v/” in very) are caused by a constriction in the airway that generates the turbulent flow. Similarly, plosives (e.g., “/p/” in put) create a turbulent flow from the initial release of air after halting the airflow through the vocal tract with the lips or tongue. Nasals (e.g., “/n/” in noise) generate turbulent flows by constricting the vocal tract and forcing sound through the three acoustic sinuses: maxillary, sphenoid, and frontal. Following a plosive with a fricative creates an affricative (e.g., “/dz/” in judge) phoneme which constitutes less than 1% of English phonemes. Transitions in airflow from one phoneme to the next constitute the last of the categories. While glides (e.g., “/w/” in what) connect consonant sounds with vowels in a smooth transition of airflow, diphthongs (e.g., “/oi/” in coin) connect two vowel sounds. Glides and diphthongs make up approximate 3% and 7% of all phonemes, respectively.

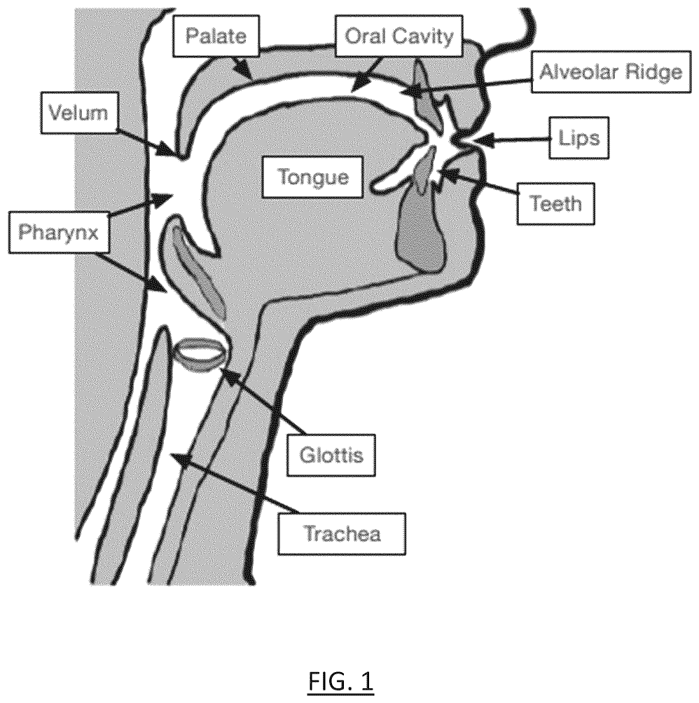

Phonemes are the fundamental building blocks of speech. Each unique phoneme sound is a result of different configurations of the vocal tract components shown in FIG. 1. Human audio production is the result of interactions between different components of the human anatomy. The lungs, larynx (i.e., the vocal chords), and the articulators (e.g., the tongue, checks, lips) work in conjunction to produce sound. The lungs force air through the vocal chords, inducing an acoustic resonance, which contains the fundamental (lowest) frequency of a speaker's voice. The resonating air then moves through the vocal cords and into the vocal tract. Here, different configurations of the articulators are used to shape the air in order to produce the unique sounds of each phoneme.

Human created speech is fundamentally bound to the anatomical structures that are used to generate it. Only certain arrangements of the vocal tract are physically possible for a speaker to create. The number of possible acoustic models that can accurately reflect both the anatomy and the acoustic waveform of a speaker are limited. Alternatively, synthetic audio is not restricted by any physical structures during its generation. It is highly improbable that models used to generate synthetic audio will mimic an acoustic model that is inconsistent with that of an organic speaker. As such, synthetic audio can be detected by modeling the acoustic behavior of a speaker's vocal tract.

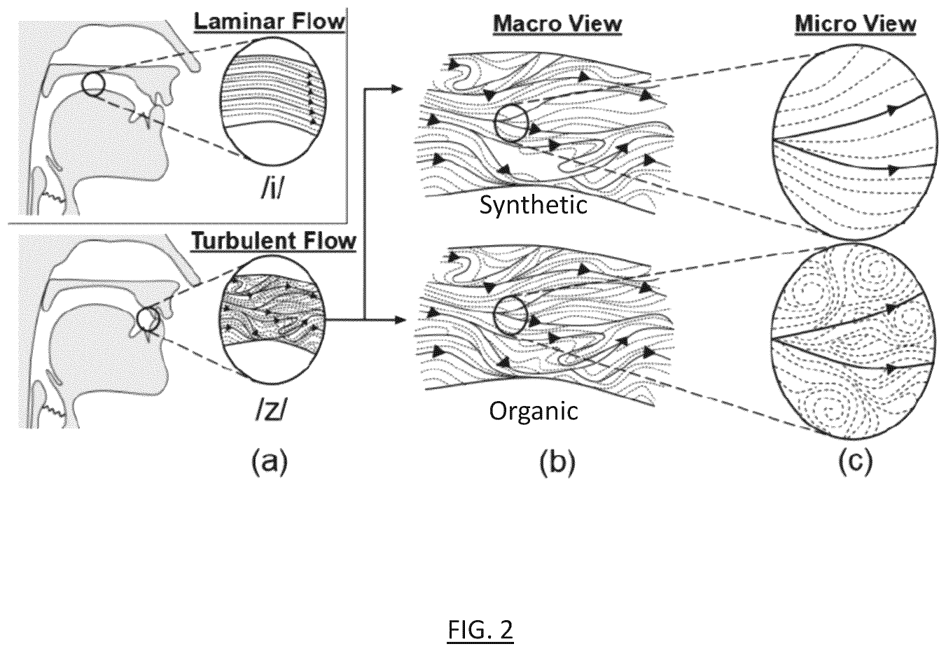

Fluid dynamic flow is classified as either laminar flow or turbulent flow. FIG. 2 illustrates examples of both a laminar and a turbulent flow. Laminar flows are orderly and well-structured with different fluid “layers” combining to make up the whole flow. These layers tend to remain separate from one another as long as the flow remains laminar. In contrast, turbulent flows are chaotic and lacking in structures. Different fluid sections within a turbulent flow tend to mix and collide with one another resulting a less predictable, slower flow. Visually, laminar flow is smooth and uniform, such as in a column of water that is formed when water is slowly poured from a glass. Turbulent flow is often visualized as having a rough surface and small eddies localized swirling and reverses of overall flow) similar to river rapids.

A Reynolds Number is used to determine whether a given fluid flow is laminar or turbulent. The Reynolds Number is calculated as follows:

$$R e = \frac{ρ u L}{μ} \qquad ( 1 )$$

Where ρ is the density of the fluid, u is the velocity of the flow, L is the characteristic linear dimension determined by the fluid's container, and μ is the dynamic viscosity of the fluid. It is common to consider the Reynolds Number as a ratio between the largest and smallest scales for which turbulence dominates. At lower Reynolds Numbers, most fluid flows are dominated by laminar flow. As the Reynolds Number increases, the flow becomes more dominated by turbulence.

Laminar flows are more commonly used in science and engineering sine they are simpler and easier to analyze. However, laminar flows are considerably less common in the real world than the more complex turbulent flow. Turbulent flows are used by humans to form many of the basic sounds from which languages are constructed. Broadly, turbulent flows are classified by five properties: three-dimensional, multi-scaled, unsteady, mixing, and intermittent.

Fluid dynamic turbulence is fundamentally a three dimensional phenomena. Simplifying turbulence to a two dimensional problem results in drastically different fluid behavior that does not help predict or analyze the three dimensional problem. Thus, turbulence must be considered without the aid of a spatial simplification. All of the various characteristics of a turbulent flow exist at a variety of different temporal and spatial scales. If an observer were to focus in on a small local region of turbulent flow, it presents all of the same characteristics of the larger flow. Within turbulence, there does not exist a smaller spatial or temporal window where a more structured laminar flow exists.

Turbulent flows cannot be fixed, evolve with time, and are inherently chaotic. Small alterations to the initial conditions of a flow result in significantly different outcomes. Longer and larger flows will differentiate themselves faster than shorter and smaller flows. The longer and larger a flow is, the more chaotic fluid behavior there is to be expected. For these reasons, no two turbulent flows are exactly the same. Laminar flows maintain structured layers of fluid such that the molecules of the fluid that enter the flow near one another will likely end the flow near one another as well. In contrast, turbulent flows result in high degrees of fluid mixing, making the likelihood of the molecules remaining near one another effectively zero. The local amount of turbulence within a region of a flow is not static, and thus the Reynolds Number for a given flow does not remain constant with respect to either time or space. This means that within a given flow there can be areas that are more turbulent than others. These regions of increased turbulence will also vary in time, meaning that a point of local maximum turbulence is not guaranteed to persist throughout time.

Turbulence flows are typically modeled statistically rather than computationally or mathematically. However, statistical models are limited by not only the data used, but the statistical technique as well. For this reason, more accurate and efficient computational simulations have been developed in the field of computational fluid dynamics. Acoustically, turbulence results in a constantly shifting, non-deterministic alternation to the underlying sound. Turbulent flows are often described as sounding like a hissing noise.

The acoustic effects of turbulence, especially in the presence of existing sounds in human speech, are very complex in nature. By altering the fluids within the vocal tract, turbulence will also affect other acoustic phenomena such as resonance. These phenomena result in a standing pressure wave at a certain frequency within the vocal tract that is determined by the length of the resonating chamber. The frequency of the standing wave is amplified while other frequencies are repressed, resulting in a dominant frequency called a formant frequency. Depending on the circumstances, turbulence may increase or decrease the resonating effect, resulting in a wobbling amplitude of the resonating formant frequency. Alternatively, the turbulence could cause localized high pressure zones that effectively alter the shape of the resonance chamber, causing shifts in the formant frequency being driven. Despite its chaotic nature, however, humans are able to manipulate turbulent flow enough to generate different sounds using it, for example/z/and/s/in the words “zap” and “sip.” Despite both the/z/and/s/phonemes being primarily created through turbulent flows, we are still able to differentiate the two. This is because through all the chaos within the turbulent flows, there is enough structured macro characteristics for listeners to differentiate between them.

The lungs, larynx, and articulators (e.g., lips, tongue, and checks) work together in different configurations to produce human speech. The lungs create pressure and force the air through the vocal tract. Then, the vocal folds in the larynx can be engaged to create voiced speech; if not engaged, they create unvoiced speech. Engaging the vocal folds produces an acoustic resonance that dictates the fundamental frequency of the voice. The articulators of the vocal tract then formulate the exact phoneme. We will now give a brief overview of how each of different categories of phonemes are created.

When creating a fricative, speakers force two articulators close together and force air through the gap with high air pressure (e.g., “/v/” in very is created by pulling the upper teeth and lower lip together). A plosive is formed by blocking the airway completely, allowing pressure to build. This phase of the phoneme is called the halt. Once enough pressure has built, the obstruction is removed, and air flows through the vocal tract again. Plosives result in a similar behavior to fricatives directly after releasing the halt phase of the plosive (e.g., “/p/” input is created by the turbulent flow after the lips create a stop). Nasals are made using resonant behavior like a vowel with additional turbulence caused by the tight passageways of the nasal cavity and the tight openings into the various sinuses (e.g., “hir in noise is created by bringing the tongue to the roof of the mouth and forcing air through the nasal cavities which contains several structures that cause turbulence).

Embodiments described herein focus on fricative, nasal, and plosive phonemes since they tend to be created using the most turbulence. As described above, variations to the initial conditions and various miniscule factors can cause drastically different specific flows in addition to the divergent nature of turbulence. Therefore, the small variations within the articulations of each phoneme will cause the difference between any two occurrences to diverge from one another faster. For example, the fricative/v/from earlier is defined by the distance between the upper teeth and the lower lip. This distance will vary between occurrences. Additionally, the moisture layer on the lips and teeth, the temperature and humidity content of the air inside and outside the vocal tract, the altitude of the speaker, the volume at which the speaker is talking, the speaker's cadence (which will influence both the duration the phoneme is held and the speed at which the articulators are brought together and separated), tongue position with oral cavity, etc. will all affect the nature of the turbulent flow for a specific occurrence of a phoneme. These factors will result in a greater Reynolds Number and can be thought of as a ratio between the largest and smallest scales for which turbulence dominates. This effectively means the amount of micro-structure, as seen in FIG. 2, is increased, providing a greater number of features for the system to detect.

Deepfake audio seeks to impersonate a human speaker to fool a victim into believing the audio sample comes from a human being. Attack audio can be targeted to sound like a particular speaker; however, it is not a requirement. The machine learning (ML) adversary takes three general steps to create a deepfake: learn a representation of the speaker (i.e., the encoder), generate a spectrogram from the learned representation and text (i.e., the synthesizer), and finally convert the spectrogram into an audio waveform (i.e., the vocoder). Although the specific ML techniques can differ amongst types of deepfakes, each deepfake generator follows this framework.

The encoder, generally a recurrent neural network (RNN), trains on varied utterances of the speaker's voice to learn a unique embedding for the speaker. This learned speaker embedding captures the manner in which a speaker's voice creates phonemes. The output of the encoder is then used in the synthesizer. Using the output from the encoder and desired text, a synthesizer machine learning model creates a Mel Spectrogram. The Mel Spectrogram logarithmically scales frequencies to focus on the range that humans are most sensitive to, the Mel Scale. A synthesizer without the input from an encoder creates untargeted synthetic audio (e.g., text-to-speech systems). The vocoder generates the audio waveform from the Mel Spectrogram created by the encoder. Vocoders usually consist of a convolutional neural network (CNN) architecture and is commonly a variation of Oord et al.'s WaveNet. WaveNet relies on larger filters with zeros prefilled throughout the filter to pull out larger effects throughout the waveform generation.

Although many algorithms can generate deepfakes, the tools to create audio deepfakes follow the same framework. These three steps vary in implementation but usually employ three separate machine learning models. Individual architectures for models and training procedures affect the quality of the deepfake.

The human voice is defined by the structures that create it. These structures and the articulations made during speech will often result in turbulent fluid flows within the vocal tract. Turbulent flows within the vocal tract add specific acoustic signatures to human voice and are the main acoustic phenomena in many phonemes (e.g., fricatives). As described above, turbulent flows are defined by flow characteristics of three dimensionality, multi-scaling, unsteadying, mixing, and intermittency. Machine learning models fail to accurately capture the multi-scaled and chaotic nature of the turbulent system due to the machine learning model's limited information capacity and finite resolution. This results in synthetically generated fluid flows being more structured at smaller temporal and spatial scales than real world turbulent flows. The increased structure results in a detectable change in the acoustic signature of turbulent phonemes that are created synthetically. Therefore, embodiments described herein differentiate simulated turbulent flows from those occurring in the real world by detecting these differences.

The security model of example embodiments described herein includes three parties: an adversary, a victim, and a defender. The adversary's goal is to create a deepfake audio sample of the victim speaker that can be incorrectly attributed to the victim. It should be noted that the victim can be a generic human target. The defender's goal is to be able to prevent this incorrect attribution and to determine if an unknown audio sample was spoken by the victim speaker. It is assumed that the defender does not know the victim, thus preventing the defender from querying the victim about the audio sample.

The interactions between the adversary and the defender occur as follows: The adversary will present the defender with an audio sample that is either a deepfake or organic audio. The defender will then need to determine whether the audio was created organically or generated synthetically by a machine. If the defender is able to correctly identify the source of the audio, the adversary has lost.

In the security model described herein, it is assumed that the adversary has access to enough audio samples of the victim's voice and access to the computational power to create a modern deepfake. It is further assumed that the defender has no knowledge of the model architecture, training parameters, or training data used to create the model. Furthermore, it is assumed that the defender does not have access to any audio samples of the speaker ahead of time.

Embodiments described herein operate in two phases. The first phase is referred to as the seeding phase, used to bootstrap a uniquely seeded detector instance. The second phase is referred to as the detection phase, which validates audio samples as either organic or synthetic in origin. The seeding phase begins by selection of a series of random seed values. These values are used to transform a small selection of known organic audio samples as training data into a classification space. Each of the dimensions of the classification space are normalized per phoneme. A threshold value is then calculated from the normalized classification space values to be used in the detection phase. The seeds, normalization factors, and thresholds are preserved for use in the second detection phase.

Once the detector has been seeded, audio samples can be processed. During the detection phase, unknown audio samples are processed similarly to the organic training samples. Unknown audio samples are transformed into the classification space, normalized, and then compared to the previously calculated threshold values. This process happens continuously as long as audio data is being fed to the detector. Each individually processed phoneme is labeled with a vote for either organic or synthetic. These votes will be accumulated over the length of the audio sample until the audio can be labeled as either organic or synthetic.

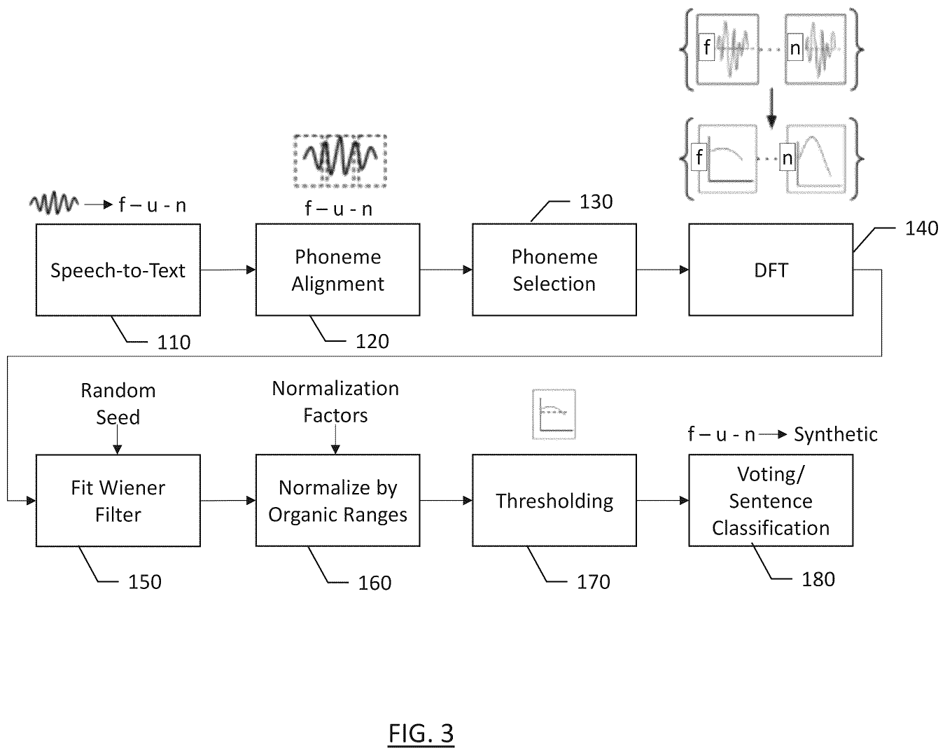

The seeding and detection phases share many of the same processes, such that the two processes are described herein together. FIG. 3 depicts a process flow of an overview of embodiments described herein when in the detection phase. There is an important distinction between the seeding and detection phases. During the seeding phase, only known organic data will be processed since embodiments of the present disclosure work by detecting missing real-world components rather than model-specific errors. The detection phase, however, processes unknown data of both organic and synthetic origins.

Embodiments described herein require phonetic timing information to operate. To label the incoming audio samples with the correct phoneme timestamps, the audio is initially transcribed to text. A Speech-to-Text API tool can be employed for speech transcription as shown at 110 of FIG. 3. The transcriptions and the original audio samples are then passed to another tool that is a forced phonetic aligner based on a Kaldi model which is a toolkit often used by automatic speech recognition systems. This aligner tool provides timing information about the individual phonemes in a given piece of audio as shown at 120 of FIG. 3.

Once phonetically aligned, the phonemes to evaluate are selected. As described above, fricatives, plosives, and nasals are expected to contain the most turbulence, rendering them the ideal phonemes to process. Thus, the in-coming audio samples are filtered to only contain the fricative, plosive, and nasal phonemes as shown at 130 of FIG. 3. A Discrete Fourier Transform (DFT) is applied to each audio sample at 140. The DFT is a special case of the Laplace Transform that converts audio samples from a time domain signal into the complex frequency domain. Thus, the DFT allows for the extraction of the relative amounts of acoustic frequencies within each sample. The extracted frequency data is referred to as the frequency response. However, the outputted frequency response values are required to have a fixed size for the rest of the described techniques to function properly. For this reason, the DFT size is fixed to 2,048 bins. Additionally, the frequency responses are normalized such that the greatest absolute magnitude of any frequency bin is equal to one.

To transform the frequency response data into the classification space, a Wiener filter is used. This filter is a linear time-invariant filtering technique that has traditionally been used for noise reduction. Wiener filters function by computing a statistical estimation of an unknown signal by using a related known signal. The unknown signal is referred to herein from this point on as the observed signal and the known signal as the “seed” signal. Effectively, the Wiener filter attempts to find an ideal linear transformation mapping the observed signal to the seed signal. The created filter can be used to filter out similar noise profiles for future observed signals.

If the filter is shorter than the incoming signal, it can be applied multiple times to process the full signal. However, the Wiener filter is not used by embodiments described herein for denoising the incoming signal. Instead, the linear coefficients that make up the Wiener filter are collected and used as a new representation of the signal itself. That is to say, the Wiener filter coefficients represent the transformation of the sample into the classification space.

According to example embodiments described herein, a Wiener filter is a filter whose weights are found via the minimization of the mean square error between the calculated output of the Wiener filter, y, and the seed signal, x′. This is derived as follows: First, y is calculated at a discrete timestep, n, from the original signal, x. Second, the matrix form of y is formulated at discrete timestep, n. Third, the error e is quantified between y and the seed signal x′ at timestep n, then the general form of the error is shown. From this, the minimization of the mean square error is derived, and thus the solution for the Wiener coefficients, w, is the solution of the system of linear equations of the autocorrelation matrix and the correlation matrix.

Consider at discrete timestep n with original signal x, Wiener coefficients w with size P. The following is calculated:

$$y [ n ] = {\sum }_{k - 1}^{P - 1} w [ k ] x [ n - k ] \qquad ( 2 )$$

Where k represents the offset of the signal (e.g., when k=1, the filter coefficient is multiplied with the previous observed signa, x[n−1]). The above equation is formulated to matrix form by letting [xₙ, xₙ₋₁, . . . , x_{n-P+1}], thus the scalar output, y, is:

$$\begin{matrix}y = {w}^{T} x \\ = {x}^{T} w\end{matrix} \qquad ( 3 )$$

The error, e, at timestamp, n is the difference between the output of the filter, y, and the seed signal, x′. Formally:

$$\begin{matrix}e [ n ] = {x}^{′} [ n ] - y [ n ] \\ = {x}^{′} [ n ] - {w}^{T} x\end{matrix} \qquad ( 4 )$$

The notation from Equation (4) is then generalized. For any n in the original signal with size, N, and filter size, P. Equation (4) becomes:

$$e = {x}^{′} - X {w}^{T} = ( \begin{matrix}{x}^{′} [ 0 ] \\ {x}^{′} [ 0 ] \\ ⋮ \\ {x}^{′} [ N - 1 ]\end{matrix} ) - ( \begin{matrix}x [ 0 ] & x [ - 1 ] & x [ - 2 ] & … & x [ 1 - P ] \\ x [ 1 ] & x [ 0 ] & x [ - 1 ] & … & x [ 2 - P ] \\ x [ 2 ] & x [ 1 ] & x [ 0 ] & … & x [ 3 - P ] \\ ⋮ & ⋮ & … & … & ⋮ \\ x [ N - 1 ] & x [ N - 2 ] & y [ N - 3 ] & … & x [ N - P ]\end{matrix} ) ( \begin{matrix}{w}_{0} \\ {w}_{1} \\ {w}_{2} \\ ⋮ \\ {w}_{P - 1}\end{matrix} ) \qquad ( 5 )$$

In Equation (5), X is a Toeplitz matrix and when the index is a negative number (e.g., x[−1]), it represents signal indexed from the end of the sample. According to the formulation of example embodiments, N does not need to equal P. When N, the number of observed signals, is larger than P, the Wiener filter size, the problem is over-determined. Therefore, it has a unique solution with generally zero error. To find the optimal Wiener coefficients, the mean square error (MSE) is minimized, and thus E as the statistical expectation leads to:

$$\begin{matrix}E [ {e}^{2} [ n ] ] = E [ {( {x}^{′} [ n ] - X {w}^{T} )}^{2} ] \\ = E [ {x}^{′ 2} [ m ] ] - 2 {w}^{T} E [ {Xx}^{′} [ n ] ] + {W}^{T} E [ X {X}^{T} ] w\end{matrix} \qquad ( 6 )$$

Notably, r_{Xx′})=E[Xx;[n]] is the expected value of the cross-correlation matrix between the original signal and the seed signal, and R_{XX}=E[XX^{T}] is the expected value of the auto-correlation matrix of the original signal. Thus,

$$E [ {e}^{2} [ n ] ] = {r}_{x ′ x ′} [ 0 ] - 2 {w}^{T} {R}_{{Xx}^{′}} + {W}^{T} {R}_{X X} W \qquad [ 7 ]$$

And the gradient of Equation (7) is:

$$\frac{\partial }{\partial w} E [ {e}^{2} ( n ) ] = - 2 {r}_{{Xx}^{′}} + 2 {w}^{T} {R}_{X X} \qquad ( 8 )$$

Where the gradient vector is defined as:

$$\frac{\partial }{\partial w} = {[ \frac{\partial }{\partial {w}_{0}} , \frac{\partial }{\partial {w}_{1}} , \frac{\partial }{\partial {w}_{2}} , … , \frac{\partial }{\partial {w}_{P - 1}} ]}^{2} \qquad ( 9 )$$

The ideal set of Wiener filter coefficients is located by setting the error in Equation 8 to zero and solving the series of linear equations. Setting Equation 8 to zero results in:

$$w = {R}_{X X}^{- 1} {r}_{Xx ′} \qquad ( 10 )$$

This equation can be expanded into its full matrix representation as follows:

$$( \begin{matrix}{w}_{0} \\ {w}_{1} \\ {w}_{2} \\ ⋮ \\ {w}_{P - 1}\end{matrix} ) = ( \begin{matrix}{r}_{XX} [ 0 ] & {r}_{XX} [ 1 ] & {r}_{XX} [ 2 ] & … & {r}_{XX} [ P - 1 ] \\ {r}_{XX} [ 1 ] & {r}_{XX} [ 0 ] & {r}_{XX} [ 1 ] & … & {r}_{XX} [ P - 2 ] \\ {r}_{XX} [ 2 ] & {r}_{XX} [ 1 ] & {r}_{XX} [ 0 ] & … & {r}_{XX} [ P - 3 ] \\ ⋮ & ⋮ & … & … & ⋮ \\ {r}_{XX} [ P - 1 ] & {r}_{XX} [ P - 2 ] & {r}_{XX} [ P - 3 ] & … & {r}_{XX} [ P - 1 ]\end{matrix} ) ( \begin{matrix}{r}_{Xx ′} [ 0 ] \\ {r}_{Xx ′} [ 1 ] \\ {r}_{Xx ′} [ 2 ] \\ ⋮ \\ {r}_{Xx ′} [ P - 1 ]\end{matrix} ) \qquad ( 11 )$$

$$where$$

$${r}_{XX} ( k ) = \frac{1}{N} {\sum }_{m = 0}^{N - 1} y ( m ) y ( m + k ) \qquad ( 12 )$$

$${r}_{Xx ′} ( k ) = \frac{1}{N} {\sum }_{m = 0}^{N - 1} y ( m ) y ( m + k ) \qquad ( 13 )$$

These equations enable calculation the ideal solution to these linear equations and find the Wiener filter coefficient vector w. Each filter coefficient effectively represents a relationship between the values in the seed and observed signals. However, since the filter is over-determined, each filter coefficient is used multiple times throughout the filtering process, relating N-P different pairs of seed samples and observed samples. By having N-P sample pairs represented by a single coefficient, the extracted relationships from across the seed and observed samples are effectively condensed into a smaller number of values.

The application of a Wiener filter is shown in FIG. 3 at 150. The Wiener filter is given the DFT value of a single phoneme as the observed signal and a randomly selected value as the seed signal. The seed signal remains static after selection and is used with all phonemes from this point moving forward. Both the seed and the observed signal are a list of 2,048 floating point values in the range [−1, 1]. These two lists are then used to calculate a Wiener filter with a length of 50 coefficients.

By condensing the numerical relationships between the seed and observed data, embodiments concentrate on the acoustic effects of the turbulence used to generate the selected phonemes. By condensing the effects of turbulence the effects of these structures within the acoustic signal are amplified. As noted above, synthetically generated audio samples will be missing the acoustic effects of the micro details of the defining turbulent flows. Thus, by condensing the relationships between frequencies from across the samples, embodiments are able to amplify the effects that are present in the organic audio and missing in the synthetic audio.

Each phoneme is processed individually using the Wiener filter and randomly selected seed values. Thus, each phoneme DFT is used to derive a vector in the classification space. It is at this point that the seeding phase and our detection phase differ. The two phases proceed as described herein. At this point in the seeding phase, the normalization factors are calculated for each dimension of our classification space on a per-phoneme basis. This is completed by grouping the classification space vectors by phoneme and finding the maximum absolute value for each dimension. Each maximum value is saved as part of the normalization vector for each phoneme dimension pair. Additionally, all of the extracted classification vectors are normalized by these newly extracted normalization vectors. During the detection phase, the normalization vector calculated during the seeding phase is used. Thus, embodiments divide each dimension within the current classification vector by its corresponding dimension in the normalization vector.

Once the phoneme is processed using the Weiner filter, the absolute value of the normalized classification space vector is summed for each phoneme, effectively reducing it down to a single value. This value is referred to as the phoneme classification magnitude. The effects of turbulence within the organically generated samples result in larger magnitudes than that of the synthetically generated samples. The process of normalizing and summing the magnitude vectors is represented in FIG. 3 at 160. These magnitudes are then used in a statistical voting scheme we will described below.

Embodiments described herein need to determine and enforce a threshold to detect whether or not a phoneme classification magnitude is organic or synthetic in origin. Thus, the seeding and detection phases once again deviate from one another. The seeding phase is responsible for extracting the necessary thresholds from strictly organic samples, while the detection phase will compare unknown samples to those thresholds.

Threshold extraction is done during the seeding phase on strictly known organic samples. The thresholds described herein are derived by creating an empirical distribution function of all the classification magnitudes derived from a given phoneme in the training data. The 5th percentile value is then selected as the threshold for the current phoneme. This means that each phoneme will have its threshold value calculated during this phase.

Threshold application and vote accumulation occur only during the detection phase. Each phoneme's classification magnitude is compared to the threshold value derived in the seeding phase. If the classification magnitude from the unknown sample is less than the threshold, a vote is made for the sample to be synthetic. A vote of organic is made if the value is greater than or equal to the threshold.

Since the threshold is set at the 5th percentile of organic speech samples, there is a high chance that organic speech will be misclassified. By repeating this process multiple times and voting on multiple phonemes as they appear in the speech, the likelihood that the underlying statistics will take over is increased. This process is repeated until enough phonemes have been collected to make an accurate assertion of the audio's origin. At that time, embodiments check to see if the total number of votes of synthetic is over 5% of the votes. If so, then the audio file is officially labeled as being synthetically generated.

The TIMIT acoustic-phonetic continuous speech corpus is a commonly used dataset for speech recognition systems. It consists of speech samples taken from 630 American English speakers with 8 different dialects each saying ten distinct sentences. Each of these sentences is lexically and phonetically transcribed, where each element is delineated in time. Each audio sample has a sampling rate of 16 kHz. The existing TIMIT data is modified by embodiments herein with deepfake audio samples created using the Real-Time-Voice-Cloning (RTVC) tool. This tool is a widely used publicly available deepfake generation tool. RTVC implements a voice synthesizer along with a vocoder. To create deepfakes of the TIMIT audio samples, all ten samples from each speaker were concatenated form a master speaker sample. This master sample was then used to train an RTVC model to create deepfakes of that individual speaker. That model was then used to generate deepfake samples of each of the original ten audio samples.

To verify the process of example embodiments described herein, 500 organic samples were randomly selected as the organic training set. This set in total contained 3963 individual fricative, plosive, and nasal phonemes. An additional 250 organic samples and 250 synthetic samples were selected to use as a validation set. This dataset contains 5699 organic phonemes and 6647 synthetic phonemes. Finally, an additional 500 organic and 500 synthetic audio samples were selected to be used as our testing dataset. There are 5102 and 5676 phonemes in the organic and synthetic datasets respectively.

The ASVspoof2021 dataset is the fourth edition of the challenge, in which participants have to design countermeasures to protect automatic speaker verification (ASV) systems from manipulation. This dataset includes logical access (LA), physical access (PA), and speech synthetic audio (DF). Embodiment described herein employed the DF track audio, as it includes all of the deepfake audio. Audio samples are short, with an average of approximately 2.5 seconds, and are generated using voice-conversion (VC) systems, text-to-speech (TTS), and a hybrid of the two (TTS_VC). The voice-conversion (VC) systems use neural networks and spectral filtering, while the text-to-speech (TTS) systems use waveform concatenation or neural network speech synthesis with a voice-conversion. Only six of the systems are introduced in the training and development datasets, while the evaluation consists of twelve generation methods. In total, 257 organic (i.e., bona fide) and 257 synthetic audio samples were selected to confirm functionality embodiments described herein. This dataset contains 3102 and 2854 organic and synthetic phonemes, respectively.

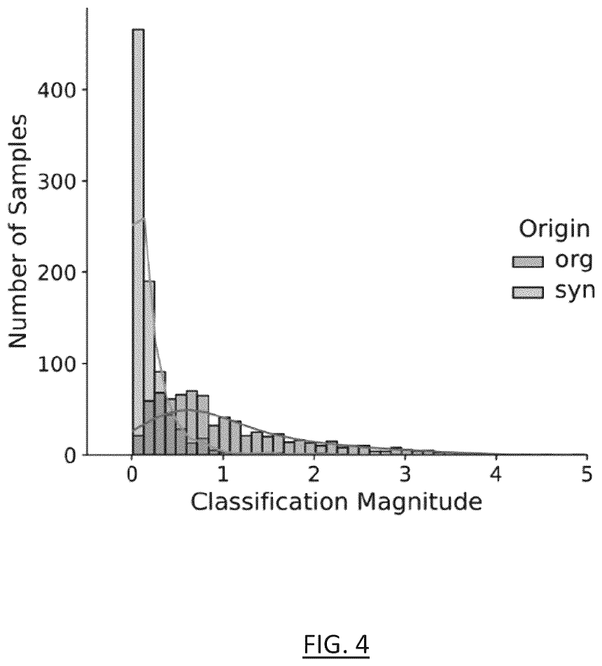

The classification magnitudes of organic audio data are statistically larger than that of synthetically generated data, as evidenced by embodiments of the present disclosure. Embodiments of the process described herein are employed using the seeding phase on the training dataset described above. The collection of seeds normalization vectors, and thresholds defined during the seeding phase are considered the seeded deepfake detector. The validation dataset is processed using the same seed detector. FIG. 4 illustrates the distribution of the classification magnitudes for both organic and synthetic phonemes. The organic samples are often larger than their synthetic counterparts which appear to be largely grouped near zero. This demonstrates that the process described herein successfully concentrates the turbulent effects as described above.

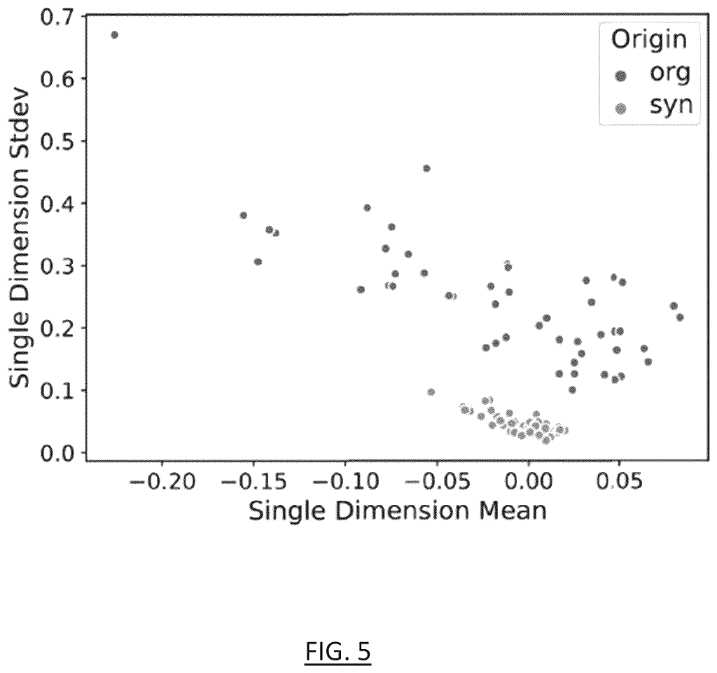

Furthermore, an increased magnitude of the organic samples should not be isolated to a small number of dimensions within the classification vector. FIG. 5 illustrates the mean (x-axis) and standard deviation (y-axis) of the values for each of the 50 dimensions within the classification vectors. It is shown that the organic data is more spread out, having large mean and standard deviation values than the synthetic data. This indicates that the increased magnitude of the classification vector is not isolated to a single or small number of dimensions. This follows that the effects of turbulence are visible across the classification vector.

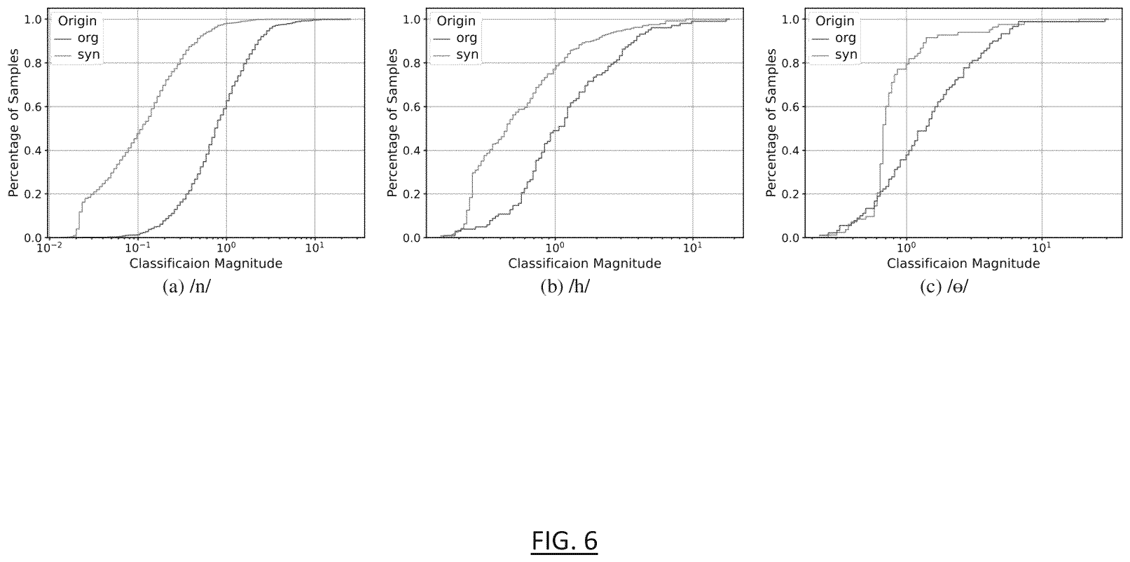

The 5th percentile threshold selection can be demonstrated through the classification magnitude distributions of individual phonemes. FIG. 6 illustrates empirical cumulative distribution functions (ECDF) for the three phonemes: /n/,/h/, and/e/. The x-axis of the graphs of FIG. 6 is the classification magnitudes for phonemes in the validation dataset and the y-axis represents the percentage of phonemes that have a classification magnitude of the current x value or less. For example, in the/n/phoneme ECDF, the organic data with a classification magnitude of 10⁻¹ has a corresponding percentage value of 0.01. This represents that 1% of all organic/n/phonemes have a classification of 10-1 or less.

FIG. 6 illustrates that the organic data increases less rapidly than the synthetic data. This difference between synthetic and organic data is fundamentally what embodiments described herein capture using the selected thresholds. The thresholds are selected to be the 5th percentile of the organic data. As shown for the/n/and/h/phonemes, by selecting the 5th percentile for organic data, a much larger percentage of synthetic data is below that line. Thus, the selected threshold has a 5% chance of inaccurately flagging an organic phoneme as synthetic, but a much greater chance of correctly flagging a synthetic phoneme. The exact performance of thresholding for an individual phoneme is not necessarily known. The phoneme/e/in FIG. 6 is not effective for differentiating organic and synthetic samples. In the lower classification magnitudes, the two datasets are nearly identical before separating like the other phonemes around a magnitude of 0.6. This is above the 5th percentile for this phoneme and will not aid in the differentiating process. Short of understanding which phonemes will and will not work for a given deepfake model, all plosive, nasals, and fricative phonemes are processed by embodiments described herein. This keeps the technique from being reliant on model-specific knowledge.

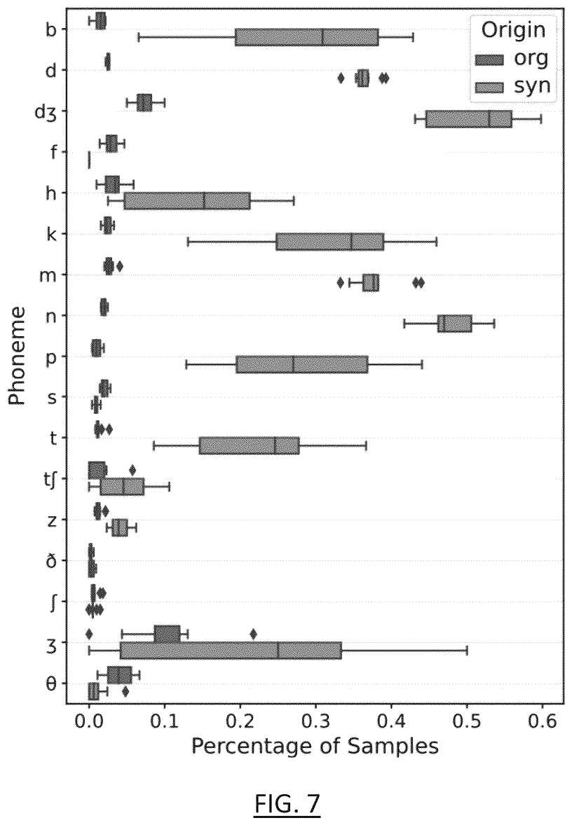

To demonstrate the effects of different phonemes using techniques described herein, ten seed values are selected to create ten different seeded detectors, each with normalization vectors and thresholds. Each detector is created using the training data described above. The validation set is processed with each of the detectors to extract classification magnitudes. The output from each detector is then grouped by phoneme and dataset. This divides all of the classification magnitudes by detector, origin, and phoneme. The analysis then determines a percentage of each phoneme that is less than the selected 5th percentile threshold. The results of this analysis are illustrated in FIG. 7. The x-axis illustrates the different phonemes, while the y-axis is the percentage of phonemes flagged as synthetic. Each bar within the graph represents the results of the ten different detectors that were seeded.

From FIG. 7 it is shown that the phonemes can vary in performance. Certain phonemes act as ideal differentiators between organic and synthetic audio (e.g., /d/,/k/,/n/) while others provide little to the task (e.g., /Õ/ or /∫/). Further, the spread of the data indicates that the seed selection does impact effectiveness of embodiments described herein. Certain phonemes are seed-indifferent (e.g., /m/,/d/,/t/), producing a similar level of performance across all ten seeds. Other phonemes are more sensitive to the seed selection (e.g., /b/ and /k/)

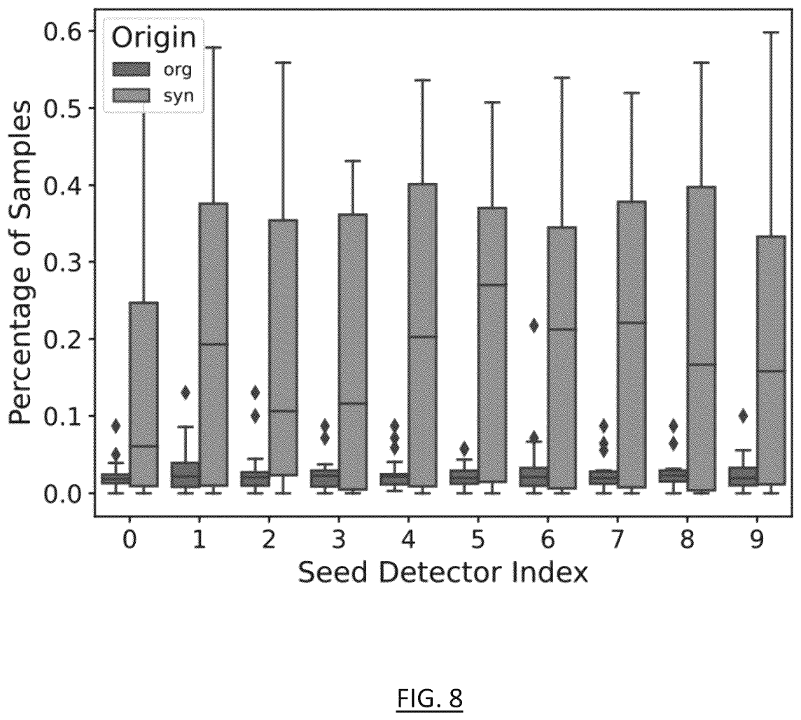

Embodiments provided herein are analyzed to demonstrate the effects of the randomly selected seed to determine if different seeds result in considerable degradation of the performance of the detector. For this analysis, the overall performance of each seed is evaluated using the ten detectors described above to generate FIG. 8. According to FIG. 8, the data is grouped by seeded detector (x-axis) while maintaining the same percentage of phonemes flagged as synthetic on the y-axis. Thus, the bars are made up of the flagging rate of the different phonemes detected. According to the synthetic distributions, the different seeds result in broadly similar distributions with minimum values near the expected organic rate of 5% and maximum values above 50%. This is commensurate with FIG. 7 in which some phonemes were universally similar to organic samples (e.g., /Õ/ or /S/) whereas others were universally ideal differentiators (e.g., /d/,/k/,/n/). However, the mean values shown in FIG. 8 are highly relevant. As shown across the differently seeded detectors, every mean value is greater than the expected organic rate of 5%. This indicates that regardless of the seed value used, the deepfake detectors of example embodiments described herein perform well. However, the mean values within the synthetic datasets do fluctuate. This can result in certain seed values performing less well than others. For this reason, embodiments can employ multiple seed detectors at once and all voting information is accumulated into a single decision.

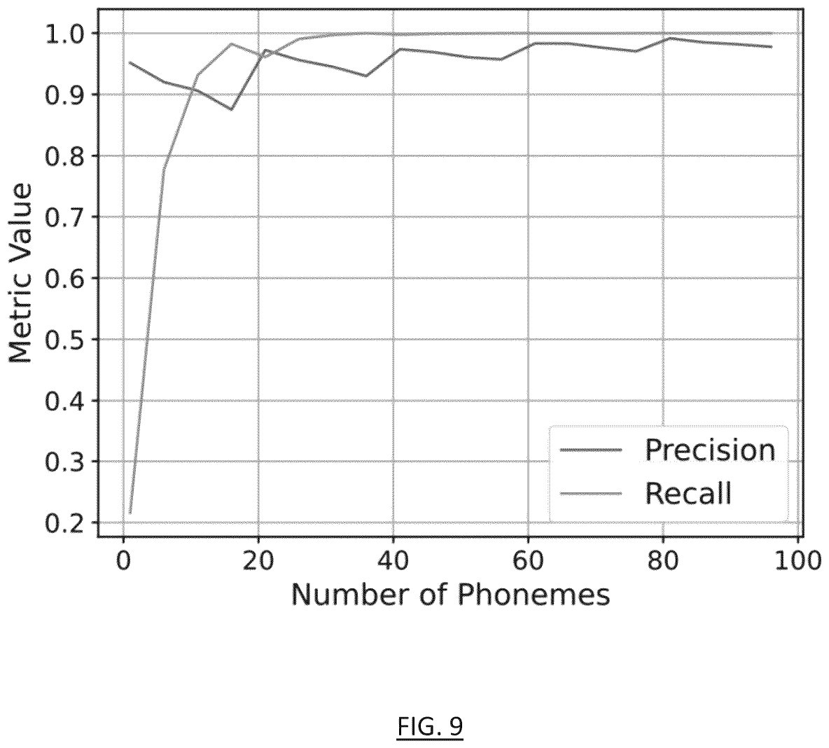

The overall performance of the deepfake detector of example embodiments can be evaluated using the ten detectors to process the testing data described above. For purposes of evaluation, the test data is novel to the detectors to remove any bias that may filter into the process. After each detector has processed all of the audio samples, all phonemes are grouped into a single collection. This results in each phoneme within the dataset getting ten different votes (synthetic or organic), with one from each detector. The way in which any particular detector votes is not material, rather the vote itself is. A fixed number (N) of phonemes are selected of either organic or synthetic origin. The votes from these N samples are then accumulated and checked to see if more than 5% of the phonemes are labeled as synthetic. It is then checked to see if the label is correct. This process is repeated 1,000 times for each value of N. After 1,000 iterations, the precision and recall are calculated for the simulation. FIG. 9 illustrates results for the precision and recall for these simulations as N is swept from 1 to 100.

As shown in FIG. 9, the precision and recall values increase as more phonemes are processed. A recall rate of 100% is achieved after approximately 33 phonemes. The percentage of phonemes processed is around 44% of the phonemes spoken in the English language. Assuming the average English word contains seven phonemes and a comfortable speaking cadence of 100 words-per-minute, roughly 700 phonemes can be expected every minute. As such, on average around 6.5 seconds or 10 words of speech are needed before achieving this level of recall. A precision value of 99.16% can be achieved with embodiments of the deepfake detector described herein within the first 100 phonemes. It can be expected to collect 100 phonemes in around 19.5 seconds of speech, or around 32 words. The precision value continues to trend upwardly as additional phonemes are tested.

The deepfake detector of example embodiments was further evaluated to determine transferability between different datasets. The ASVspoof2021 dataset described above was used for its popularity and familiarity within the field. The majority of samples in this database are short, measuring only 1-3 seconds in length. The techniques described herein rely on continuous evaluation of a statistically relevant number of phonemes before performance becomes acceptable. Specifically, under the favorable conditions the TIMIT dataset allows, embodiments need approximately 6.5 seconds of audio before converging. Further, the length of the ASVspoof audio samples make them much shorter than ideal, unlike deepfakes that are anticipated to be most impactful to society at large. Deepfakes are deployed to fool listeners such that they can be exploited. Whether the adversary is trying to provoke the listener to perform some action (e.g., provide authorization, transfer money, go to a URL, etc.) or deface the victim in the case of a targeted deepfake (e.g., the person who the deepfake is designed to sound like), the adversary will require much more than 1-3 seconds of audio.

The quality of the audio samples in the ASVspoof dataset is also low, resulting in substantially a worst-case scenario for embodiments of the deepfake detector described herein. Due to these factors, three phonemes were identified that seemed to be mis-transcribed at least in the ASVspoof and these phonemes were analyzed by the deepfake detector described herein. These phonemes include/n/,/b/, and /f/.

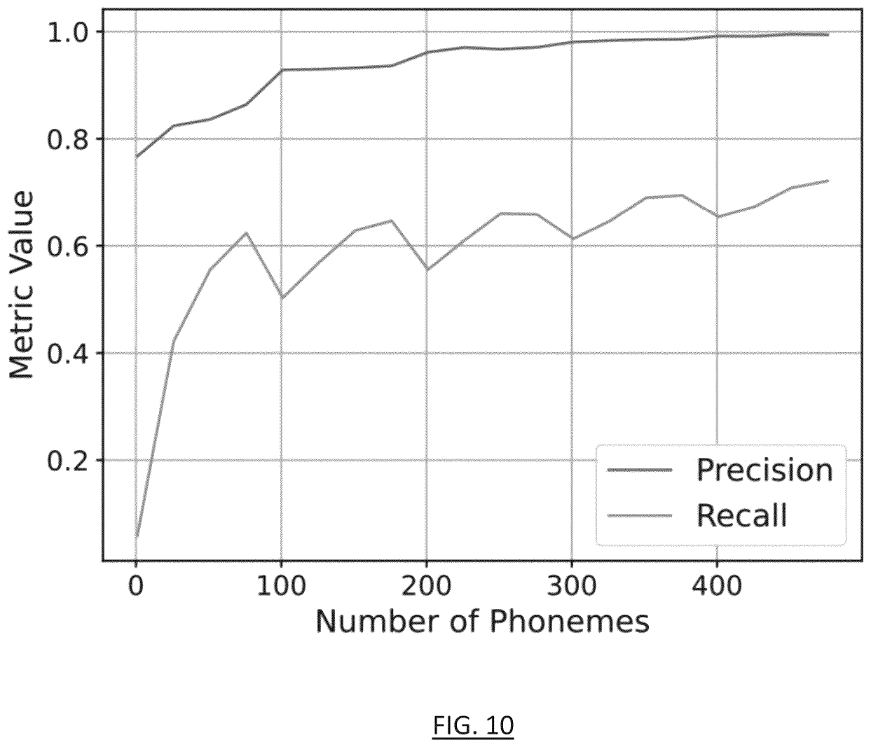

FIG. 10 illustrates results using the ASVspoof dataset. Embodiments of the deepfake detector described herein are eventually able to achieve a precision rate of 99.38% and a recall rate of 72.15%. Both of these results required a considerable amount of phonemes to be processed before being achieved, which is anticipated given the quality of the audio and the short duration of the audio files. The high precision rate achieved indicates that the detector of example embodiments described herein is not prone to false positives. This is a benefit in a possible deployment scenario since the deepfake detector of example embodiments will not regularly give false alarms or falsely hinder an organic speaker. As the deepfake detector described herein performs better over time, the lower recall rate can be offset by running the deepfake detector for longer in real-world scenarios.

Performance of embodiments of the deepfake detector described herein benefit from properly phonetic labeling. The effect of misclassifications and poor alignment of phonetic labeling is mitigated by using statistics collected over longer durations. As embodiments described above statistically take around 6.5 seconds to reach convergence and achieve higher than 99% precision, the time required is based on the inherently unstable nature of turbulence. The process requires multiple examples of turbulent phonemes before an accurate assessment of the origin of the audio can be made. As the majority of deepfakes that have any consequence will require significant durations of generated speech, the deepfake detector described herein is well suited to the task of separating organic audio from synthetic audio.

Embodiments of the deepfake detector described herein operate in two distinct phases. The seeding phase is more computationally intensive; however, it only needs to be run once. During this phase, the detector's keys, thresholds, and normalization vectors are constructed. Once complete, the detector begins to operate in the second phase of the detection phase. The detection phase is capable of processing 82 phonemes per second, whereas the normal speaking rate is between 70-150 words-per-minute, or 8-18 phonemes per section. As such, the deepfake detector described herein can operate in real-time or as the words are spoken and heard.

A defender could employ multiple different deepfake detectors as described herein, each using unique seed values. These detectors could then be assembled to form a single, unified detector. The different seed values do not provide significant performance variation as described above. However, a defender may still use multiple seed values to smooth out any small performance variation between detectors or to further increase the robustness of the unified detector. By deploying multiple detectors, the defender minimizes the possibility of a bad seed compromising their security and increases the computational load of the potential adversary.

A naïve adversary may attempt to evade detection from the deepfake detector described herein by adding statistically derived noise to their audio sample during specific phonemes. This attach would not be sufficient to avoid detection as turbulent flows of speech are unsteady and intermittent. Thus, the nature of turbulent flows renders their acoustic signatures chaotic in time, frequency, and amplitude. The resulting frequency response from turbulence is an ever-changing distribution. At points of low turbulence, the frequency response from turbulence is an ever-changing distribution. At points of low turbulence, the frequency response will become more ordered with distinct peaks and values. In moments of high turbulence, the frequency response will result in a more randomly sampled, flat distribution. Tangential to those changes, the total acoustic energy within the frequency response (i.e., average amplitude) can vary throughout. The result is that the frequency response for the acoustics of turbulence will be constantly changing. This is in stark contrast to the behavior that is seen in various kinds of statistical noise. For instance, white noise is created by randomly sampling a flat distribution of possible amplitudes for every frequency. Thus, the frequency response of the white noise will remain relatively constant throughout. Therefore, the acoustics of turbulence and statistical noises share little in common.

A more advanced adversary may attempt to deploy the deepfake detection technique as a loss function to create deepfakes that can evade the detector described herein. This adversary will also fail for several reasons. First, the adversary cannot employ a simple gradient propagation algorithm to simulate the technique of example embodiments. This is because the Wiener filter at the core of the deepfake detector is over-determined and therefore performs dimension-reduction on the incoming signal. As such, the adversary cannot translate the optimal step in the classification space back to the frequency space. Thus, the adversary will need to use other, more sophisticated techniques.

Additionally, the advanced adversary will need to create, maintain, and operate multiple keyed detectors. As previously described, deployment of the deepfake detector described herein can employ the use of multiple seeds to both decrease the likelihood of getting a poor seed value and increase the potential robustness of the detector. In such a case, an adversary would need to operate several different seeded detectors while training. Finally, the adversary would have to overcome multiple seeds. The random seed values fundamentally alter the classification coefficients, normalization vectors, and phoneme thresholds. Thus, it is unlikely that a model trained specifically to evade a detector using one seed will transfer to a detector with a different seed. This would allow a defender to nullify the work of an adversary by simply using a detector with a new seed.

Generative machine learning models have made convincing voice synthesis a reality. While such tools can be extremely useful in applications where people consent to their voices being cloned (e.g., patients losing the ability to speak, actors not wanting to have to redo dialog, etc.), they also allow for the creation of unconsented content as “deepfakes”. This malicious audio is problematic not only because it can convincingly be used to impersonate arbitrary users, but because detecting deepfakes is challenging and generally requires knowledge of the specific deepfake generator.

Generative audio has many positive potential applications; however, users are best able to make decisions when they are able to accurately and repeatably determine whether a source is organic or synthetic. Embodiments described herein provide an audio deepfake detection technique based on measuring turbulence in human-sounding speech. Embodiments demonstrate that while measuring turbulence is efficient, modeling it accurately in the speech generation process is not. By understanding this observation, embodiments demonstrate that complex natural phenomena can serve as powerful measures of what is real and what is artificially generated.

FIG. 12 illustrates a flowchart depicting methods according to example embodiments of the present disclosure. It will be understood that each block of the flowchart and combination of blocks in the flowchart may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory device of an apparatus employing an embodiment of the present disclosure and executed by a processor of the apparatus. As will be appreciated, any such computer program instructions may be loaded onto a computer or other programmable apparatus (for example, hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions that execute on the computer or other programmable apparatus provide operations for implementing the functions specified in the flowchart blocks.

Accordingly, blocks of the flowcharts support combinations of means for performing the specified functions and combinations of operations for performing the specified functions for performing the specified functions. It will also be understood that one or more blocks of the flowcharts, and combinations of blocks in the flowcharts, can be implemented by special purpose hardware-based computer systems that perform the specified functions, or combinations of special purpose hardware and computer instructions.

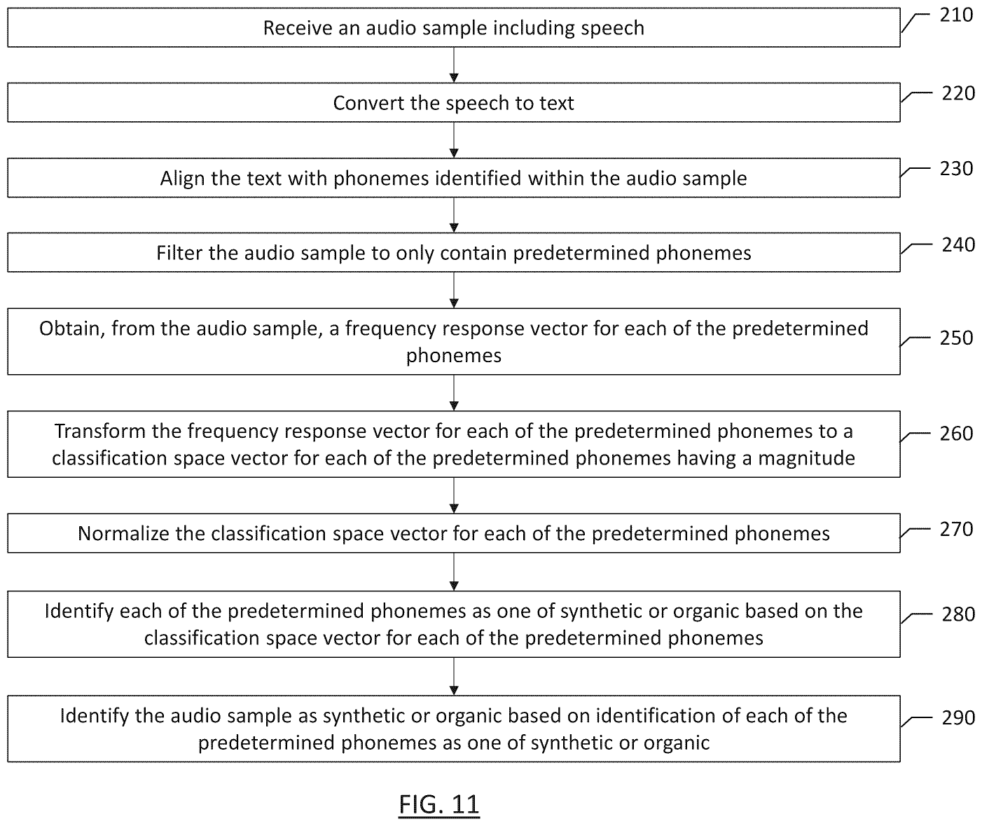

FIG. 11 illustrates a flowchart of a method according to an example embodiment of the present disclosure for identifying deepfake audio samples. According to the illustrated embodiment, an audio sample is received including speech at 210. The speech is converted to text at 220. At 230, the text is aligned with phonemes identified within the audio sample. The audio sample is filtered at 240 to only contain predetermined phonemes. From the audio sample, a frequency response vector is obtained at 250 for each of the predetermined phonemes. The frequency response vector for each of the predetermined phonemes is transformed at 260 to a classification space vector for each of the predetermined phonemes having a magnitude. The classification space vector for each of the predetermined phonemes is normalized at 270. Each of the predetermined phonemes is identified at 280 as one of synthetic or organic based on the classification space vector for each of the predetermined phonemes. The audio sample is identified as synthetic or organic at 290 based on identification of each of the predetermined phonemes as one of synthetic or organic.

In an example embodiment, an apparatus for performing the methods of FIG. 11 above may include a processor configured to perform some or each of the operations (210-290) described above. The processor may, for example, be configured to perform the operations (210-290) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 210-290 may comprise, for example, the processor and/or a device or circuit for executing instructions or executing an algorithm for processing information as described above.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. An apparatus comprising at least one processor and at least one memory including computer program code, the at least one memory and computer program code configured to, with the processor, cause the apparatus to at least:
receive an audio sample comprising speech;
convert the speech into text;
align the text with phonemes identified within the audio sample;
filter the audio sample to only contain predetermined phonemes;
obtain, from the audio sample, a frequency response vector for each of the predetermined phonemes;
transform the frequency response vector for each of the predetermined phonemes to a classification space vector for each of the predetermined phonemes having a magnitude;
normalize the classification space vector for each of the predetermined phonemes;
identify each of the predetermined phonemes as one of synthetic or organic based on the classification space vector for each of the predetermined phonemes; and
identify the audio sample as synthetic or organic based on identification of each of the predetermined phonemes as one of synthetic or organic.

2. The apparatus of claim 1, wherein the predetermined phonemes include fricative phonemes, plosive phonemes, and nasal phonemes.

3. The apparatus of claim 1, wherein causing the apparatus to transform the frequency response vector for each of the predetermined phonemes to the classification space vector for each of the predetermined phonemes comprises fitting a Weiner filter to the frequency response vector for each of the predetermined phonemes.

4. The apparatus of claim 3, wherein the Weiner filter computes a statistical estimation of the frequency response vector for each of the predetermined phonemes as an unknown signal using a related known signal.

5. The apparatus of claim 4, wherein the Weiner filter attempts to find an ideal linear transformation mapping the unknown signal to the related known signal.

6. The apparatus of claim 5, wherein the related known signal is a seed, wherein the apparatus is further caused to:
determine the seed for a given phoneme by:
grouping together the classification space vectors for the given phoneme to form a grouped classification space vector; and
finding a maximum absolute value for each dimension of the grouped classification space vector.

7. The apparatus of claim 1, wherein causing the apparatus to obtain, from the audio sample, the frequency response vector for each of the predetermined phonemes comprises causing the apparatus to:
apply a Discrete Fourier Transform to the audio sample to convert the audio sample from a time domain signal to a complex frequency domain; and
obtain the frequency response vector for each of the predetermined phonemes in the complex frequency domain.

8. The apparatus of claim 1, wherein causing the apparatus to identify each of the predetermined phonemes as one of synthetic or organic based on the classification space vector for each of the predetermined phonemes comprises causing the apparatus to:
compare the classification space vector for each of the predetermined phonemes to a threshold; and one of:
determine that one of the predetermined phonemes is synthetic in response to the classification space vector for the one of the predetermined phonemes failing to satisfy a threshold; or
determine that the one of the predetermined phonemes is organic in response to the classification space vector for the one of the predetermined phonemes satisfying the threshold.

9. The apparatus of claim 1, wherein causing the apparatus to identify the audio sample as synthetic or organic based on identification of each of the predetermined phonemes as one of synthetic or organic comprises causing the apparatus to:
identify the audio sample as synthetic in response to more than five percent of the predetermined phonemes being identified as synthetic.

10. A method comprising:
receiving an audio sample comprising speech;
converting the speech into text;
aligning the text with phonemes identified within the audio sample;
filtering the audio sample to only contain predetermined phonemes;
obtaining, from the audio sample, a frequency response vector for each of the predetermined phonemes;
transforming the frequency response vector for each of the predetermined phonemes to a classification space vector for each of the predetermined phonemes having a magnitude;
normalizing the classification space vector for each of the predetermined phonemes;
identifying each of the predetermined phonemes as one of synthetic or organic based on the classification space vector for each of the predetermined phonemes; and
identifying the audio sample as synthetic or organic based on identification of each of the predetermined phonemes as one of synthetic or organic.

11. The method of claim 10, wherein the predetermined phonemes include fricative phonemes, plosive phonemes, and nasal phonemes.

12. The method of claim 10, wherein transforming the frequency response vector for each of the predetermined phonemes to the classification space vector for each of the predetermined phonemes comprises fitting a Weiner filter to the frequency response vector for each of the predetermined phonemes.

13. The method of claim 12, wherein the Weiner filter computes a statistical estimation of the frequency response vector for each of the predetermined phonemes as an unknown signal using a related known signal.

14. The method of claim 13, wherein the Weiner filter attempts to find an ideal linear transformation mapping the unknown signal to the related known signal.

15. The method of claim 14, wherein the related known signal is a seed, wherein the method further comprises:
determining the seed for a given phoneme by:
grouping together the classification space vectors for the given phoneme to form a grouped classification space vector; and
finding a maximum absolute value for each dimension of the grouped classification space vector.

16. The method of claim 10, wherein obtaining, from the audio sample, the frequency response vector for each of the predetermined phonemes comprises:
applying a Discrete Fourier Transform to the audio sample to convert the audio sample from a time domain signal to a complex frequency domain; and
obtaining the frequency response vector for each of the predetermined phonemes in the complex frequency domain.

17. The method of claim 10, wherein identifying each of the predetermined phonemes as one of synthetic or organic based on the classification space vector for each of the predetermined phonemes comprises:
comparing the classification space vector for each of the predetermined phonemes to a threshold; and one of:
determining that one of the predetermined phonemes is synthetic in response to the classification space vector for the one of the predetermined phonemes failing to satisfy a threshold; or
determining that the one of the predetermined phonemes is organic in response to the classification space vector for the one of the predetermined phonemes satisfying the threshold.

18. The method of claim 10, wherein identifying the audio sample as synthetic or organic based on identification of each of the predetermined phonemes as one of synthetic or organic comprises:
identifying the audio sample as synthetic in response to more than five percent of the predetermined phonemes being identified as synthetic.

19. A computer program product comprising at least one non-transitory computer-readable storage medium having computer-executable program code instructions stored therein, the computer-executable program code instructions comprising program code instructions to:
receive an audio sample comprising speech;
convert the speech into text;
align the text with phonemes identified within the audio sample;
filter the audio sample to only contain predetermined phonemes;
obtain, from the audio sample, a frequency response vector for each of the predetermined phonemes;
transform the frequency response vector for each of the predetermined phonemes to a classification space vector for each of the predetermined phonemes having a magnitude;
normalize the classification space vector for each of the predetermined phonemes;
identify each of the predetermined phonemes as one of synthetic or organic based on the classification space vector for each of the predetermined phonemes; and
identify the audio sample as synthetic or organic based on identification of each of the predetermined phonemes as one of synthetic or organic.

20. The computer program product of claim 19, wherein the predetermined phonemes include fricative phonemes, plosive phonemes, and nasal phonemes.
